(19) United States
(12) Patent Application Publication
(10) Pub. No.: US 2026/0367895 A1
(43) Pub. Date: Nov. 19, 2026

(54) Choice Constructs

(71) Applicant: Zoho Corporation Private Limited, Kanchipuram District (IN)

(72) Inventors: Sridhar Vembu, Tenkasi (IN); Akshhayaa S, Kanchipuram District (IN); Joseph Sathya Kumar, Chennai (IN)

(73) Assignee: Zoho Corporation Private Limited, Kanchipuram District, TN (IN)

(21) Appl. No.: 19/432,523

(22) Filed: Dec. 24, 2025

Related U.S. Application Data
(60) Provisional application No. 63/840,352, filed on Jul. 8, 2025.
(60) Provisional application No. 63/915,350, filed on Nov. 11, 2025.

(30) Foreign Application Priority Data
May 19, 2025 (IN) 202541048263
Sep. 25, 2025 (IN) 202541092129

(51) Int. Cl. G06F 8/41

(52) U.S. Cl. CPC G06F 8/4441; G06F 8/41; G06F 8/443

(57) ABSTRACT

A programming language and compiler support a choice conditional branching construct that allows programmers to define a variable with a choice of values, based on corresponding conditions, which are mutually exclusive. Extensions to the choice construct are done outside of the construct definition to include new conditions within a file or in a different file. The compiler checks whether the newly added conditions in the extension are mutually exclusive with the conditions defined in the choice construct. The compiler also supports a choice construct that includes a condition without an expression and an expression without a condition, where the undefined conditions and expressions are included in the construct extension.

### CROSS REFERENCE TO RELATED APPLICATIONS

This application claims priority to U.S. Provisional Applications 63/840,352 filed 8 Jul. 2025 and entitled “Choice Construct” and 63915350 filed 11 Nov. 2025 and entitled “Choice Constructs,” both of which are incorporated herein by reference.

### FIELD OF THE INVENTION

Embodiments of the present disclosure are related, in general, to computer programming languages and methods for compiling conditional branching constructs.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 provides an example of source code 100 with an illustrative definition 105 of a choice construct used for water management.

FIG. 2A depicts a choice-construct extension 200 that extends the functionality of the choice construct of FIG. 1 from outside choice-construct definition 105.

FIG. 2B depicts a source-code snippet 250 in which choice-construct definition 105 for water “quality” is extended within a file and a new conditional block is defined in lines 19 and 20.

FIG. 3 is a flowchart 300 outlining how a compiler compiles a choice-construct extension in accordance with one embodiment.

FIG. 4A depicts an abstract-choice construct defined in source code 400 of a “water_management” file.

FIG. 4B depicts an extension defined in source code 405 of choice construct defined in source code 400 of FIG. 4A.

FIG. 5A depicts an abstract choice construct defined in source code 500 in which an expression is not defined.

FIG. 5B depicts an abstract choice extension defined in source code 505 in a file separate from file of FIG. 5A and that includes an expression defined for the same abstract expression (tds>500 of FIG. 5A).

FIG. 5C depicts an abstract choice construct extension defined in source code 510 to include an expression for an abstract expression within the same “water_management” file.

FIG. 6 is a flowchart 600 illustrating a method of compiling source code 100 and encountering abstract choice-construct extensions within a file or in different files.

FIG. 7 is a flowchart 700 illustrating compiler support for runtime concurrent processing of mutually exclusive conditions within a choice construct.

FIG. 8A depicts a compiler 800 with a choice-construct manager in accordance with one embodiment.

FIG. 8B is a block diagram of choice-construct manager 815, which receives an IR of source code and performs validations on choice constructs to generate a choice-construct-managed IR.

### DETAILED DESCRIPTION

A computer program comprises a set of statements written in a programming language. Human developers and programmers write computer programs using high-level programming languages that are highly abstracted from computer hardware to make programming easier. A compiler, itself a computer program, translates so-called “source code” written in a high-level programming language into a lower-level language, such as machine code, so that it can be executed by a computer. A programming language and compiler disclosed herein support a choice conditional branching construct that allows programmers to define a variable with a choice of values, based on corresponding conditions, which are mutually exclusive. Mutual exclusivity enables safe parallel condition evaluation, a significant optimization unavailable in “if/else” or “switch” control flow structures. The choice construct can be defined within a type, struct, function, iterator/loop, main body of the program and another choice construct.

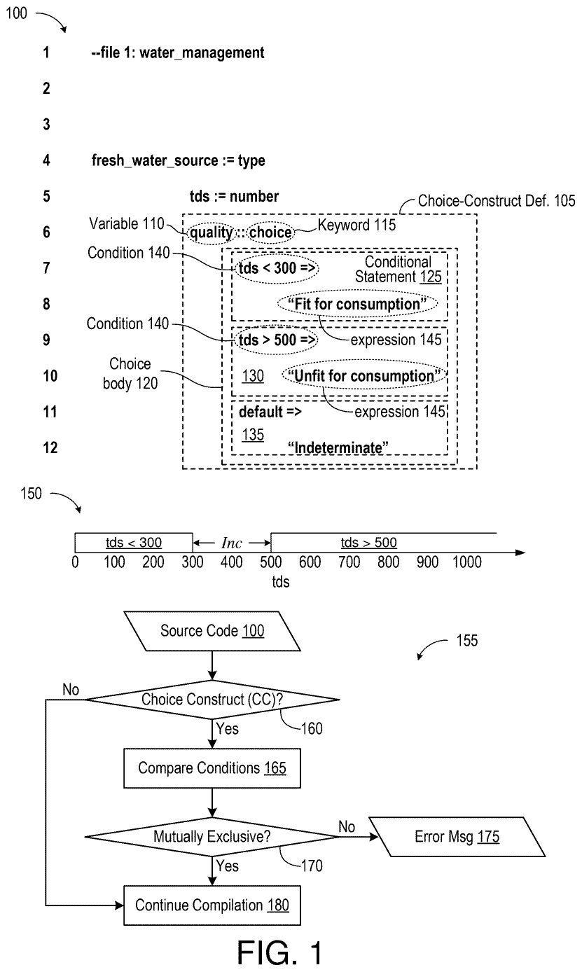

FIG. 1 provides an example of source code 100 with an illustrative definition 105 of a choice construct used for water management. The choice construct of definition 105 is a conditional branching construct that includes a choice construct variable 110 (quality), a choice keyword 115 (choice), and a choice body 120 that in turn includes three conditional statements 125, 130, and 135. Keyword 115 indicates that the construct is a conditional construct. Choice body 120 determines a value of choice-construct variable 110 from one of conditional statements 125, 130, and 135 whose condition evaluates to “true.” A conditional block/statement includes a condition 140 and a corresponding expression 145, where expression 145 can include one or more computations to determine the value of a variable. Choice-construct definition 105 is to evaluate water quality taking as input a number indicative of a measure of “total dissolved solids (tds)” using mutually exclusive conditions. Per conditional statement 125, if tds is less than 300, the water under consideration is deemed to be “Fit for consumption.” If greater than 500, conditional statement 130 produces “Unfit for consumption.” Values of tds outside of the considered ranges are evaluated as “Indeterminate.”

The careful reader may have noticed that conditional statements 125 and 130 have non-overlapping conditions 140, an observation illustrated using non-overlapping ranges tds<300 and tds>500 in a diagram 150. The two ranges that the conditions cover do not overlap and the conditions are mutually exclusive.

A flowchart 155 illustrates a method of identifying whether the conditions of choice constructs are mutually exclusive. Source code 100 or an intermediate-level representation (IR) thereof is compiled. Beginning with decision 160, if the compiler encounters a choice construct (CC), then conditions 140 are compared (165). Per decision 170, if the conditions are not mutually exclusive, the compiler issues an error message 175 and otherwise continues compilation (180). A suitable compile-time error message 175 might read: “Conditions are not mutually exclusive: include mutually exclusive conditions.” The mutual exclusion check of the choice construct is helpful in avoiding repetition of conditional blocks with the same conditions in the definition file by the developer. The mutual exclusion check also supports parallel evaluation of conditions of the choice construct at runtime.

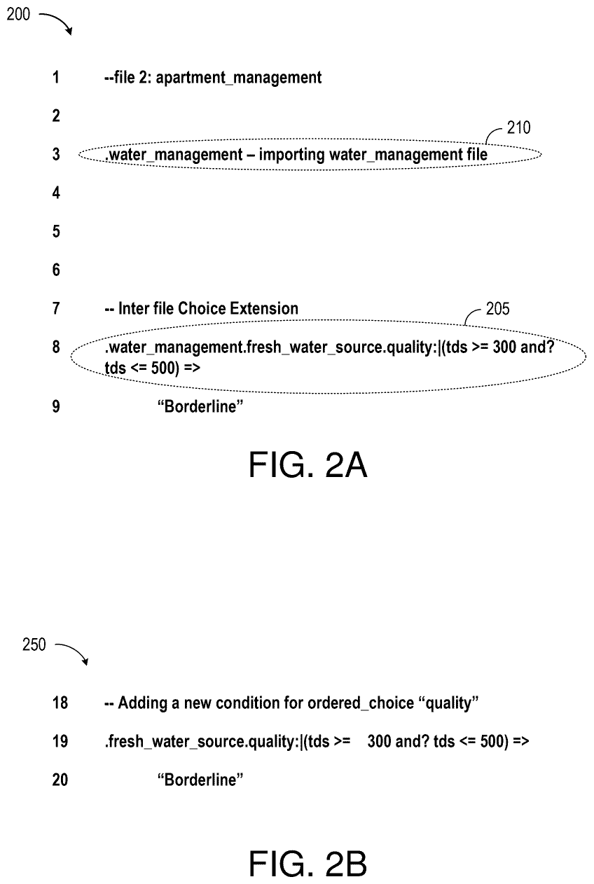

FIG. 2A depicts source code 200, a choice-construct extension that extends the functionality of the choice construct of FIG. 1 from outside choice-construct definition 105. In this context, a “construct” is a building block of a programming language, such as a class, function, or data structure. The extension by conditional block 205 modifies the capability of the construct of definition 105 from outside the definition or visibility boundary of the construct, thus allowing developers to adapt or enhance the construct of definition 105 without modifying the original source code.

The “apartment_management” of source code 200 is a file, a named collection of stored data, containing source code, instructions, or resources for compilation. Files are discrete units of data, like a single document, identified by a file name and extension (e.g., .c or “.java” for source files for the C or Java programming languages). Compilers can associate files with logical units that inherently create separate namespaces to avoid naming conflicts with other parts of the code. The “apartment_management” file of source code 200 imports the water-management file defined in FIG. 1 by source code 100. The file of source code 200 (cc_extended_file) extends the file of source code 100 (cc_defined_file) with a new conditional block 205. The choice construct of definition 105 is extended as e.g.

“indicator.choice_construct_variable: | (new-condition)” in another file with a new condition. The extension requires importing the file that includes the definition of the choice construct in the extended file. By importing a file of a choice construct (cc_defined_file) in the extended file, the conditional blocks of the choice construct are imported. The new conditional blocks are specific to the extended file that has added them.

The compiler identifies the choice construct corresponding to the extension using an indicator, a dedicated extension keyword, that includes a choice-construct variable. Once the respective choice construct for the extension is identified using the indicator, the compiler checks whether the newly added condition in the extension and the conditions within the construct are mutually exclusive. The “indicator” can also include at least one of a type name, function name, or nested choice construct variable referencing the enclosing construct within which the choice construct is defined. The enclosing construct includes at least one of a type, struct, function, loop, or nested construct. In the case of inter-file extension, the indicator includes the file name in which the construct is defined.

If the choice construct is defined within a function “find_quality”, then the indicator in the extension can be given as “find_quality.quality”. The choice construct can be nested within another choice construct, where the indicator for the extension of the inner construct includes the nested choice construct variable and the respective condition within which the inner construct is defined. If the construct “quality” is defined within a second condition (which is “a>2000”) of another choice construct “concat_quality”, then the extension of “quality” has the indicator “concat_quality| (a>2000).quality”, where “concat_quality” is the choice construct variable of the outer construct, “|” symbol represents the choice construct and “(a>2000)” is the second condition of outer choice construct within which “quality” is defined.

The file “apartment_management” (source code 200) imports the “water_management” file (source code 100) of definition 105 via an import statement 210 and new conditional block 205 (lines 8 and 9). The “--” in the source code (line 7) represents a comment throughout the document. The definition of choice construct “quality” is present in type “fresh water_source” of “water_management” file. Hence, line 8 includes the “.water management.fresh_water_source.quality” for the new conditional block with condition “tds>=300 and? tds<=500”. In the exemplary source code, “and?” represents a “logical AND” that a conditional block returns a Boolean value.

FIG. 2B depicts a source-code snippet 250 in which choice-construct definition 105 for water “quality” is extended within a file and a new conditional block is defined in lines 19 and 20. The new conditional block is defined outside the choice construct definition in water management file of source code 100. For choice construct extension, the compiler combines the conditional blocks in cc_defined_file and newly added conditional blocks in cc_extended_file in the IR.

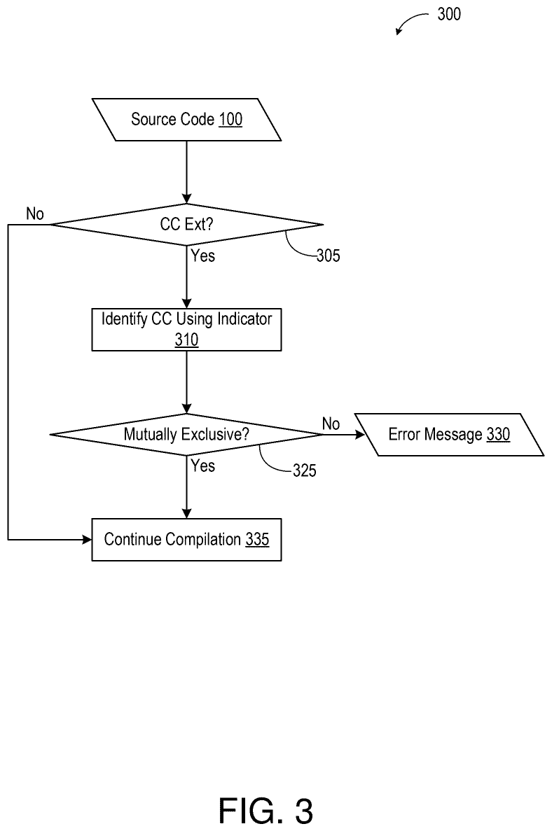

FIG. 3 is a flowchart 300 outlining how a compiler compiles a choice-construct extension in accordance with one embodiment. In doing so, the compiler combines any conditional blocks in a file with a choice-construct definition with conditional blocks in choice construct extensions in the IR.

Per decision 305, when the compiler encounters a choice-construct extension, the compiler attempts to identify the corresponding choice construct using the extension's indicator (310). It also identifies the enclosing construct within which the corresponding choice construct is defined using the indicator. If a corresponding choice construct is not defined within the enclosing construct, the compiler issues an error message. In the case of inter-file extensions, the file where a choice construct is defined (cc_defined_file) is identified from the indicator. Next, per decision 325, the compiler checks whether the new condition or conditions is mutually exclusive with the conditions in the choice-construct definition. If not, the compiler issues an error message 320. If so, then compilation proceeds (step 335). Though not shown, the compiler generates an IR for the choice construct combining together all its existing and new conditional blocks defined anywhere in source code within the same file or in different files.

The compiler expects a “default” conditional block to be defined for the choice construct when the conditions do not cover all the cases, and can throw an error message asking the developer to provide a “default” conditional block if all cases are not covered. In choice-construct extensions within a file or in different files, the compiler verifies if existing conditions of the choice construct and new conditions defined in any choice-construct extensions cover all the cases. The compiler can include a default condition in the IR unless all cases are covered by the existing and new conditions.

In the example of FIG. 1, the choice construct “quality” in “water_management” file (cc_defined_file) includes the conditions “tds>300” and “tds<500”. The apartment_management file (cc_extended_file) in FIG. 2A provides a new condition “tds>=300 and? tds<=500” to choice construct “quality”, in FIG. 1. The extension conditions are “tds<300”, “tds>500” and “tds>=300 and? tds<=500”, which cover all the cases (i.e. the entire range of “tds” values). Given this complete coverage, the “default” condition (with its corresponding expression) is not required and is consequently omitted from the IR. Hence, the IR of “quality” choice construct does not include a “default” conditional block. The compiler does not allow defining a default conditional block in any of the choice-construct extensions. If a default conditional block is defined in choice-construct extensions, then the compiler throws an error.

A choice construct can be defined with an abstract condition or an abstract expression. An expression is a combination of operands (values, variables, etc.) and operators that evaluate to a single value, a fundamental building block of code used to perform calculations, comparisons, or manipulate data. An abstract expression in a choice construct refers to a conditional block that defines a condition without a corresponding expression, whereas an abstract condition refers to a conditional block that defines an expression without a corresponding condition. A choice construct with an abstract condition or expression is referred to as an “abstract choice construct.” Abstract choice constructs can be extended within a file or in a different file(s) to define expressions and conditions for abstract expressions and conditions.

The compiler can determine whether a default conditional block is required based on static analysis of a choice-construct variable's type and the covered value space. In some embodiments, a default block may be omitted only if the compiler can statically prove that the defined conditions exhaustively cover all possible values of the variable. This proof can be limited to: Enumerated types, Boolean types, Bounded integer ranges, and Pattern-matched unions where all variants are covered. For all other types-including float, double, unbounded int, string, pointers, or user-defined types without exhaustive pattern matching-require a default block. If a required default block is omitted, the compiler issues an error: “Non-exhaustive conditions: ‘default’ required for type ‘T’.”

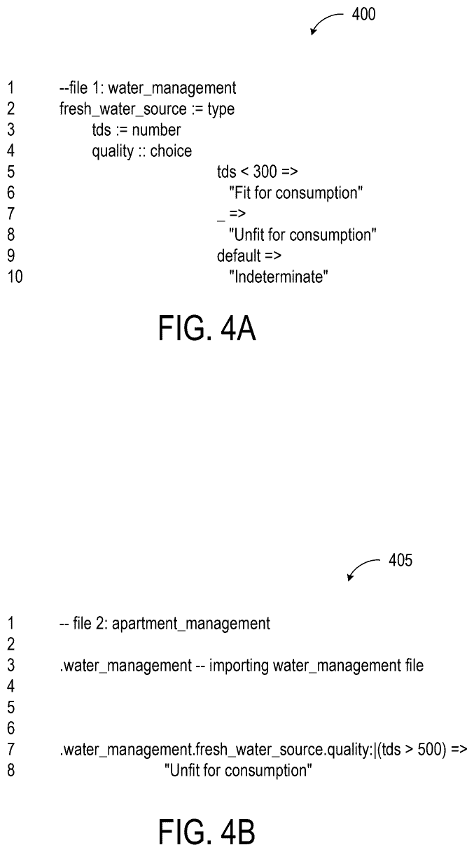

FIG. 4A depicts an abstract-choice construct defined in source code 400 of a “water_management” file. An abstract choice construct “quality” includes an abstract condition of a conditional block in line 7 and 8 (“Unfit for consumption”) without a corresponding condition. The condition is provided for the abstract condition in one or more choice-construct extensions. The “_” in the place of a condition represents that it is an abstract condition of a conditional block without a condition.

FIG. 4B depicts an extension defined in source code 405 of choice construct defined in source code 400 of FIG. 4A. The abstract choice construct “quality” is extended in a different file, “apartment_management”, where a condition specific to the “apartment_management” file is defined for the abstract condition (“Unfit for consumption”) in lines 7-8.

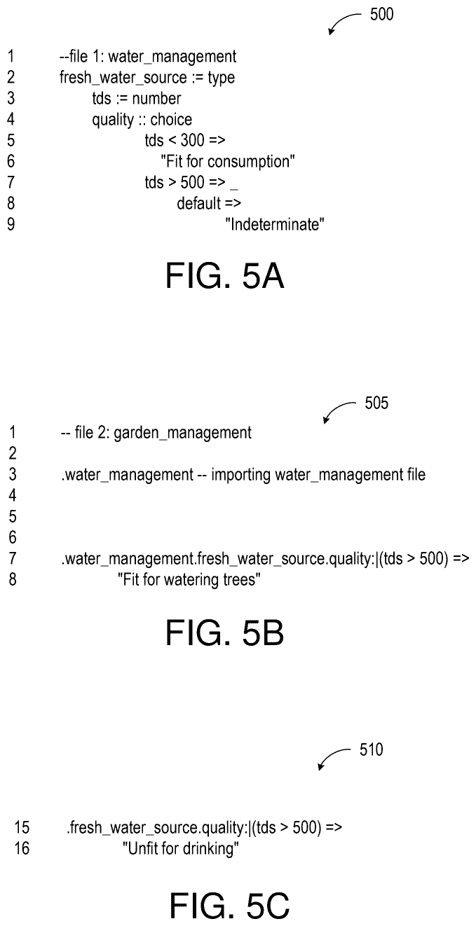

FIG. 5A depicts an abstract choice construct defined in source code 500 in which an expression is not defined. Such a construct can be extended within the same or different file to define an expression for that abstract expression. In this example, the abstract choice construct “quality” in line 4 includes an abstract expression in line 7 (tds>500) whose expression is not defined. The abstract choice construct “quality” is extended in a different file which is “apartment_management” file where an expression specific to “apartment_management” file is defined for the abstract expression in line 8 of FIG. 5B.

FIG. 5B depicts an abstract choice extension defined in source code 505 in a file separate from file of FIG. 5A and that includes an expression defined for the same abstract expression (tds>500 of FIG. 5A).

FIG. 5C depicts an abstract choice construct extension defined in source code 510 to include an expression for an abstract expression within the same “water_management” file. The abstract choice construct “quality” is extended within a file to define an expression (“Unfit for drinking” in lines 16 and 17) to abstract expression (tds>500 in line 7 of FIG. 5A).

When an abstract choice construct is encountered in the source code, the compiler checks if extension of the abstract choice construct is allowed. In a specific implementation, this check verifies whether the symbol “::” is used in the definition of the construct. If the declaration symbol is not “:: “, then the compiler generates a compile-time error and asks the developer to use the”:: “symbol to make the abstract choice construct extensible. In an alternate implementation, if the declaration symbol is not”:: “, then the compiler throws an error for missing condition or expression of conditional block for choice construct and asks the developer to define it. In a specific implementation, the compiler asks the developer to define missing conditions or expression of conditional block instead of “_” in the abstract choice construct.

The compiler generates a compile-time error when it detects an attempt to access an abstract choice construct. This occurs because the abstract choice construct contains undefined abstract conditions or expressions, leading to an execution error if accessed without proper definitions. As a result, the compiler halts and throws an error during compilation to prevent such access. For instance, if the compiler encounters access statements targeting the ‘quality’ abstract choice construct, it flags an error at compile-time. The abstract choice construct is extended within a file or across files, with concrete definitions provided for its abstract conditions and expressions.

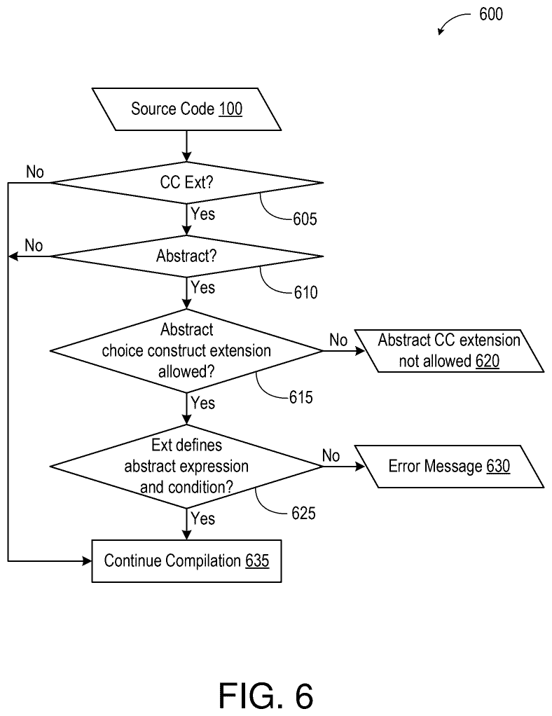

FIG. 6 is a flowchart 600 illustrating a method of compiling source code 100 and encountering abstract choice-construct extensions within a file or in different files. Per decisions 605, if the compiler encounters a choice-construct extension, then it verifies if the extended choice construct is an abstract choice construct (decision 610). If so, then the compiler checks if extension of abstract choice construct is allowed (decision 615). If extension is not allowed, then the compiler throws an error message 620 alerting the developers that the requisite choice construct extension is not allowed. In such a case, the abstract choice construct has to be made extensible (e.g. making the declaration symbol of the abstract choice construct “::”).

If the abstract choice construct extension is allowed, then the compiler checks whether the abstract choice construct extension provides definitions to abstract conditions and expression of conditional blocks (decision 625). If the extension provides an expression to an abstract expression and a condition to an abstract condition, then the compiler continues compilation (step 635). Otherwise, a compile-time error message 630 is thrown alerting the developer that the abstract choice construct that is extended has to define the abstract expression and condition.

Some embodiments employ a choice_based_on construct that is highly useful for embedded, scientific, or dataflow systems. The definition of a choice_based_on construct includes an input list of variables for evaluating conditions based on the variables. The syntax for an exemplary choice_based_on construct is:
1 y=choice_based_on(<input list of variables>)
2 conditions based on input list of variables

### Code Snippet 1: Syntax for Choice_Based_on Construct

For example,

Code Snippet 2: Choice based on specific data types

| | |
|---|---|
| 1 | y :: choice_based_on(a, b, c) |
| 2 | a > b => |
| 3 | c * 100 |
| 4 | a < b => |
| 5 | c / 100 |
| 6 | a == b and? c == 100 => |
| 7 | 42 |
| 8 | default => |
| 9 | a * 100 |

In Code Snippet 2, “y” is defined as a choice_based_on construct whose conditions are based on “a”, “b” and “c” variables. Lines 2 to 9 are the conditional blocks where the conditions are based on only the input list of variables “a”, “b” and “c”. When the compiler encounters a condition that is not based on the list of variables, it throws an error. For example, if a condition for choice_based_on construct “y” is not based on “a”, “b” and “c” variables, then the compiler throws an error. The variable in the input list can be a singleton, sequence or a set of elements or objects. For example, y=choice_based_on(a [ ], b { }, c) where “a [ ]” is a sequence and “b { }” is a set. The variable in the input list can also be a slice of sequence, for example, choice_based_on(a[1 . . . 5]) where the conditions should be based on the first five elements of sequence “a”.

In choice_based_on construct extension, the compiler checks if the newly added conditions involve only the list of variables given in the construct definition. If the new conditions in extensions involve a variable out of input list given in choice_based_on construct definition, then the compiler throws an error.

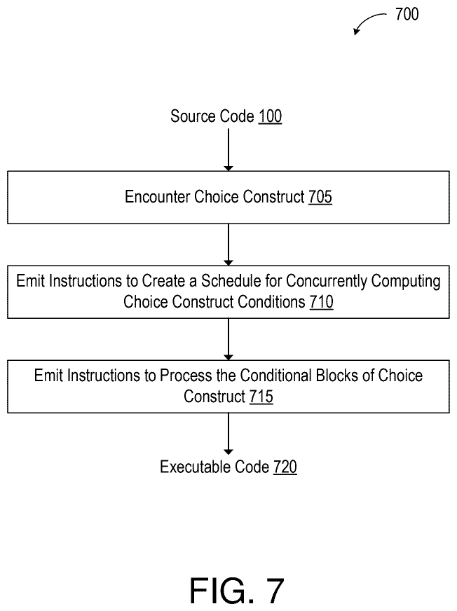

FIG. 7 is a flowchart 700 illustrating compiler support for runtime concurrent processing of mutually exclusive conditions within a choice construct. An additional mutual exclusivity check at runtime can be introduced by the compiler. In one embodiment, this check serves as an alternative to the mutual exclusivity check at compile time. On encountering a choice construct (705), the compiler emits instructions into the IR to create a schedule for concurrently evaluating the conditions of the choice construct (710). The compiler also emits instructions to process the conditional block (715). Instructions can be generated and inserted into source code, or can be generated in an IR format and included with the larger IR representation for further compiling in the IR phase. In various other embodiments, the instructions may be introduced in one or more differing stages of compilation. The resultant compiled instructions will yield comparable expected performance results at runtime, but the compilation process itself may differ in performance depending on the embodiment.

The emitted instructions provide functionality to create a schedule for concurrent computation of the conditions whenever the target machine allows it. The results obtained from the concurrent evaluation of the conditions are processed to determine the result from the expression whose condition is met. The result from the expression may be assigned to the variable corresponding to the condition of that expression evaluating to true. In one embodiment, if more than one condition evaluates to true, a runtime message is generated to indicate that the mutual exclusivity criterion is violated. In another embodiment, the result of the choice construct is chosen as the one that corresponds to the condition evaluation that returns a TRUE value, the earliest in the concurrent processing.

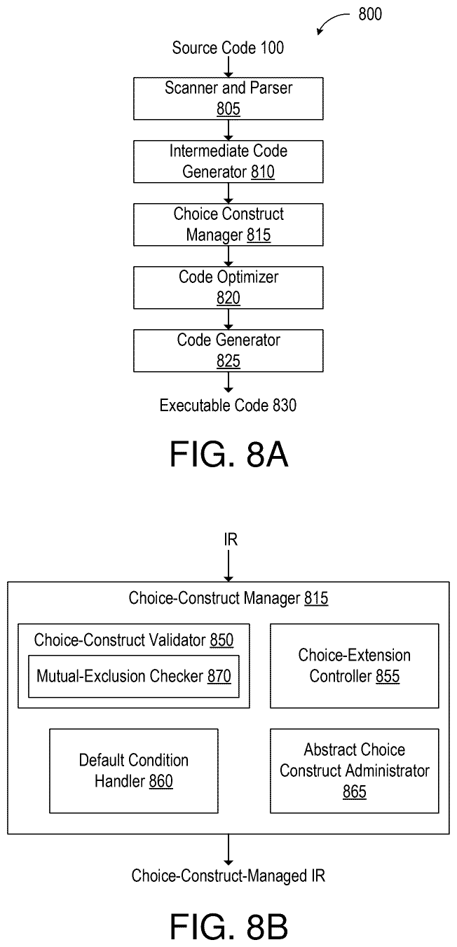

The compiler supports mechanisms to check that the conditions of a choice construct are mutually exclusive to facilitate safe concurrent runtime processing. In one embodiment, a mutual exclusion check is performed at compile-time, which is described separately herein. In another embodiment, a mutual exclusion check is performed at runtime. In yet another embodiment, mutual exclusion checks are performed at compile-time and runtime. FIG. 8A depicts a compiler 800 with a choice-construct manager in accordance with one embodiment. The compiler passes through several phases to convert a source code written in a high-level programming language to executable object code. A scanner and parser 805 scans and parses source code 100 to generate a parse tree, which is then fed to an intermediate code generator 810 that generates an Intermediate Representation (IR) of source code 100. The IR is given as an input to a choice-construct manager 815 to provide a choice construct managed-IR. Choice-construct manager 815 is responsible for managing the choice branching construct in the source code. The choice-construct-managed IR is then fed to a code optimizer 820, which optimizes the validated IR for better performance. Later, the optimized IR is sent to a code generator 825 that creates executable code 830 specific to a target processor.

The IR can be any applicable data structure. In the example of FIG. 8A, the parse tree is represented distinctly from the IR, but a parse tree can itself be an IR. In an implementation in which the parse tree is an IR, the Intermediate Representation Generator Engine, as depicted in FIG. 8A with a parse tree input and IR output, may or may not be optional. In a specific implementation, the IR is also a parse tree; in a first alternative, the IR is a graph; in a second alternative, the IR is a hybrid of a tree and a graph; and in a third alternative, the IR is some other applicable data structure. Also, the parse tree (or “parse structure”) can be implemented as a graph, hybrid of a tree and graph, or some other applicable data structure.”

FIG. 8B is a block diagram of choice-construct manager 815, which receives an IR of source code and performs validations on choice constructs to generate a choice-construct-managed IR. Choice-construct manager 815 includes a choice-construct validator 850, a choice-extension controller 855, a default condition handler 860, and an abstract-choice-construct administrator 865.

Choice-construct validator 850 includes a mutual-exclusion checker 870 that checks whether two or more conditions of choice constructs are mutually exclusive. Checker 870 throws an error if the conditions are not mutually exclusive. In case of choice-construct extensions within a file or in different files, mutual-exclusion checker 870 validates whether the existing conditions and new condition(s) of extensions are mutually exclusive. If they are not mutually exclusive, then checker 870 throws an error. For a choice_based_on construct, validator 850 checks whether the conditions are based on input list of variables. If the conditions are not based on input list of variables then validator 850 throws an error.

Default-condition handler 860 checks whether conditions of a choice construct cover all the cases to decide whether a default condition is required to be included in the IR or not. Handler 860 throws an error asking the developer to provide a “default” condition with corresponding expression if the specified conditions do not cover all cases. For default condition check in cc extensions within a file or in different files, handler 860 checks if the existing conditions and new condition cover all the cases. It includes the default conditional block in the IR if the conditions do not cover all the cases. Otherwise, handler 860 does not include the default conditional block in the IR.

Choice-extension controller 855 handles the extension of cc construct within a file and in different files. When controller 855 encounters a new condition in choice-construct extensions, it fetches the choice construct associated with the new condition from the indicator. It also identifies the enclosing construct within which the corresponding choice construct is defined using the indicator. In extensions in different files, from the indicator, the file where choice construct is defined (cc_defined_file) is identified. Controller 855 checks if cc_defined file is imported in cc_extended_file.

Controller 855 also checks if a choice construct associated with the extension is defined within the enclosing construct. If a choice construct is not defined within the enclosing construct, then the compiler throws an error that the choice construct is undefined and hence a choice-construct extension is not possible. Otherwise, if the choice construct is found, then mutual-exclusion checker 870 checks that the existing conditions and new condition are mutually exclusive. If both the conditions are not mutually exclusive, then checker 870 reports an error.

In a choice based on construct extension, controller 855 checks if a newly added condition involves only the input list of variables given in the construct definition. If a new condition in an extension involves variables out of the input list, then the choice-extension controller 855 throws an error.

Abstract-choice-construct administrator 865 checks if an extension of the abstract choice construct is allowed when an abstract choice construct is encountered in the source code (with abstract expression and abstract condition). If a choice extension is not allowed, then administrator 865 suggests the developer to change the declaration symbol to “::” to make abstract choice construct extensible. In an alternate implementation, administrator 865 throws an error for a missing expression or condition when an abstract choice construct is encountered with an incomplete definition and extension. Administrator 865 also throws a compile-time error when it encounters an access of the abstract choice construct. This is because, since the abstract choice construct includes abstract expressions or conditions, the execution results in an error due to a missing condition or expression. Hence, when administrator 865 encounters any access to the abstract choice construct, it throws an error and prevents access to the abstract choice construct.

For choice-construct extensions (inter-file and intra-file), administrator 865 checks if a choice construct that is extended is an abstract choice construct. If the extended choice construct is abstract, then administrator 865 checks if extension of the abstract choice construct is allowed. If extension is not allowed, then administrator 865 throws an error that extension of abstract choice construct is not allowed. In such a case, the abstract choice construct has to be made extensible (e.g. making declaration symbol of cc as “::”). If an abstract extension is allowed, then administrator 865 verifies if the extension provides definitions to abstract expression and/or conditions. If the abstract extension does not include condition and expression to respective abstract expression or abstract condition, then administrator 865 throws an error.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Moreover, the description herein for support in a compiler for Choice Construct Manager is provided illustratively. The compiler support for Choice Construct Manager may be implemented in similar ways over various phases and passes of compilation, using the principles described herein. Therefore, the spirit and scope of the appended claims should not be limited to the foregoing description. Only those claims specifically reciting “means for” or “step for” should be construed in the manner required under the sixth paragraph of 35 U.S.C. § 112.

1. A method of compiling source code, the method comprising:
encountering, in the source code, a definition of a construct, the construct including a variable, a first condition to evaluate the variable, and a second condition to evaluate the variable; and
checking whether the first condition and the second condition are mutually exclusive.

2. The method of claim 1, further comprising generating a message responsive to the checking if the first condition and the second condition are not mutually exclusive.

3. The method of claim 1, wherein the construct includes a first expression for the first condition and a second expression for the second condition, and wherein each of the first expression and the second expression includes at least one computation to determine a value of the variable.

4. The method of claim 1, the construct further including a keyword indicating that the construct is a conditional construct, wherein encountering the definition of the construct comprises parsing the source code for the keyword.

5. The method of claim 1, wherein the construct is defined within at least one of a type and a struct.

6. The method of claim 1, wherein construct is defined within at least one of a function, a loop construct, and a nested construct.

7. The method of claim 1, wherein the construct includes an input list of variables, the method further comprising:
encountering, in the source code, an extension of the construct outside the definition of the construct and including a third condition, and
determining whether the third condition is a function of a non-constant operand outside of the input list.

8. The method of claim 7, wherein the extension includes an indicator, the method further comprising identifying the third condition of the construct using the indicator.

9. The method of claim 8, wherein the indicator includes the variable.

10. The method of claim 8, further comprising identifying the definition of the construct from a file and identifying a reference to the file using the indicator.

11. The method of claim 1, further comprising encountering in the source code an extension of the construct outside the definition of the construct.

12. The method of claim 11, wherein the extension of the construct includes a third condition of the construct to evaluate the variable.

13. The method of claim 12, further comprising checking whether the third condition is mutually exclusive with the first condition and the second condition.

14. The method of claim 1, wherein the construct includes an expression for one of the first condition and the second condition to assign to the variable if the one of the first condition and the second condition is met, the method further comprising checking outside of the definition of the construct for the other expression to assign to the variable.

15. The method of claim 1, further comprising identifying a third condition of the construct outside the definition of the construct and checking whether the third condition is redundant with at least one of the first condition and the second condition.

16. The method of claim 15, further comprising automatically removing one of the first, second, and third conditions if the third condition is redundant with at least one of the first condition and the second condition.

17. A method of compiling source code, the method comprising:
encountering a construct including a first condition and a second condition; and
generating instructions to check, at runtime, whether the first condition and the second condition are mutually exclusive.

18. The method of claim 17, further comprising generating second instructions to issue a message, at runtime, responsive to the check if the first condition and the second condition are not mutually exclusive.

19. The method of claim 17, further comprising generating second instructions to support concurrent runtime processing of the first condition and the second condition.

20. The method of claim 19, the second instructions to return a value before one of the first condition and the second condition is met.

21. The method of claim 17, wherein the construct is encountered within a definition of the construct, the method further comprising identifying a third condition of the construct outside of the definition of the construct and generating second instructions to check, at runtime, whether the third condition is mutually exclusive with respect to the first condition and the second condition.

22. The method of claim 17, wherein the first condition and the second condition are to evaluate a variable, and wherein the construct includes an expression lacking a third condition to evaluate the variable, the method further comprising checking outside of the construct for the third condition.

23. The method of claim 17, wherein the first condition and the second condition are to evaluate a variable and the construct includes a first expression to assign to the variable if the first condition is met, the method further comprising checking outside of the construct for a second expression to assign to the variable if the second condition is met.

24. (canceled)

25. (canceled)

26. (canceled)

27. (canceled)

28. A compiler system for compiling source code, the system comprising:
one or more processors; and
memory storing instructions that when executed by the one or more processors cause the system to perform operations comprising:
encountering a definition of a construct in the source code, the construct including a variable, a first condition to evaluate the variable, and a second condition to evaluate the variable;
checking whether the first condition and the second condition are mutually exclusive.

29. The compiler system of claim 28, wherein the operations further comprise encountering an extension of the construct outside the definition of the construct.

30. The compiler system of claim 29, wherein the extension comprises a third condition to evaluate the variable.

31. The compiler system of claim 30, wherein the operations further comprise checking whether the third condition is mutually exclusive with the first condition and the second condition.
